(19) United States
(12) Patent Application Publication
(10) Pub. No.: US 2025/0373281 A1
(43) Pub. Date: Dec. 4, 2025

(54) COMMUNICATION DEVICE AND COMMUNICATION METHOD THEREFOR

(71) Applicants: Beijing BOE Technology Development Co., Ltd., Beijing (CN); BOE TECHNOLOGY GROUP CO., LTD., Beijing (CN)

(72) Inventors: Zongmin LIU, Beijing (CN); Wei LI, Beijing (CN); Yafei ZHANG, Beijing (CN); Zhihong DU, Beijing (CN); Feng QU, Beijing (CN)

(21) Appl. No.: 19/038,667

(22) Filed: Jan. 27, 2025

Related U.S. Application Data
(63) Continuation-in-part of application No. PCT/CN2024/096242, filed on May 30, 2024.

(51) Int. Cl. H04B 1/44

(52) U.S. Cl. CPC H04B 1/44

(57) ABSTRACT

The present disclosure provides a communication device and a communication method. The communication device includes an antenna assembly, a determiner, and a signal converter. The antenna assembly includes a carrier structure and a plurality of antenna units arranged on an outer wall of the carrier structure. A width of a wave lobe formed by the plurality of antenna units covers a target angle range. The determiner is configured to determine one of the plurality of antenna units to be in communication connection with the signal converter, according to strengths of signals received by the plurality of antenna units from a base station. The signal converter is configured to convert a signal received by the signal converter, for access by a terminal of a user.

### TECHNICAL FIELD

The present disclosure relates to the field of communication technology, and in particular, to a communication device and a communication method therefor.

### BACKGROUND

In recent years, construction of a new maritime information infrastructure in the country is vigorous, and with the coming of the fifth generation mobile communication technology (5G), the maritime economy has ushered in new opportunities for scale development. Basic telecommunication companies are accelerating the coverage of 5G in the ocean, extending 5G empowerment to the ocean, participating in the construction of the “smart ocean”, and continuously accelerating the construction of 5G networks in the 700 MHz frequency band.

The traditional maritime communication mainly includes two types, one of which is relying on satellite transmission, this type not only requires professional equipment, but also has huge cost, and thus is difficult to support the requirements of common customers; the other is relying on the existing fourth generation mobile communication technology (4G) network covering the coastal area, this type has a short coverage distance, and is difficult to meet the requirements of the offshore customers. One more innovative scheme is that a 700 MHz coast base station ultra-far coverage is adopted to be matched with a direct broadcasting station for ferry cabins to enhance the coverage range, but an omnidirectional antenna is adopted, such that the radiation efficiency thereof is low, the size thereof is large, and the installation thereof is inconvenient. Meanwhile, the direct broadcasting station amplifies the relay of the wireless information, and a terminal adopted must be provided with a 5G module, such that the requirement on user equipment is high, and self-excitation is easy to occur under the condition that the number of ships is large, thereby seriously deteriorating the internet surfing experience.

### SUMMARY

To solve at least one of the technical problems existing in the prior art, the present disclosure provides a communication device and a communication method therefor.

Embodiments of the present disclosure provide a communication device, which includes an antenna assembly, a determiner, and a signal converter, wherein
the antenna assembly includes a carrier structure and a plurality of antenna units arranged on an outer wall of the carrier structure, and a width of a wave lobe formed by the plurality of antenna units covers a target angle range;
the determiner is configured to determine one of the plurality of antenna units to be in communication connection with the signal converter, according to strengths of signals received by the plurality of antenna units from a base station; and
the signal converter is configured to convert a signal received by the signal converter, for access by a terminal of a user.

The determiner includes a plurality of signal couplers, a plurality of signal detectors connected in one-to-one correspondence with the plurality of signal couplers, a controller, and a first selector;

the plurality of signal couplers are connected in one-to-one correspondence with the plurality of antenna units, each signal coupler is configured to couple a part of a signal received by the antenna unit connected to the signal coupler to a corresponding signal detector, and transmit another part of the signal to the first selector;

each signal detector is configured to detect a signal received by the signal detector to acquire the strength of the signal from the base station;

the controller is configured to generate a corresponding control signal according to received strengths, which are detected by the plurality of signal detectors, of the signals from the base station, and transmit the control signal to the first selector; and
the first selector is configured to determine the one of the plurality of antenna units to be in communication connection with the signal converter according to the control signal, and communicatively connect the one of the plurality of antenna units to the signal converter.

The determiner includes a plurality of signal couplers, a plurality of signal preprocessors connected in one-to-one correspondence with the plurality of signal couplers, a signal strength reader, a first selector, a controller, and a second selector;

the plurality of signal couplers are connected in one-to-one correspondence with the plurality of antenna units, each signal coupler is configured to couple a part of a signal received by the antenna unit connected to the signal coupler to a corresponding signal preprocessor, and transmit another part of the signal to the first selector;

each signal preprocessor is configured to preprocess a signal received by the signal preprocessor;

the second selector is configured to connect the plurality of signal preprocessors to the signal strength reader in turn, under control of the controller;

the signal strength reader is configured to read the signals output from the second selector under the control of the controller, to determine the strengths of the signals received by the plurality of antenna units from the base station;

the controller is configured to generate a corresponding control signal according to received strengths, which are read by the signal strength reader, the signals from the base station, and transmit the corresponding control signal to the first selector; and

the first selector is configured to determine the one of the plurality of antenna units to be in communication connection with the signal converter according to the control signal, and communicatively connect the one of the plurality of antenna units to the signal converter.

Each of the strengths of the signals includes at least a signal reception power.

Each antenna unit includes a first oscillator and a second oscillator, and the first oscillator has an operational frequency less than an operational frequency of the second oscillator.

In each antenna unit, the first oscillator and the second oscillator are arranged side by side, and a height of the first oscillator in a direction away from the carrier structure is greater than a height of the second oscillator in the direction away from the carrier structure.

In each antenna unit, the first oscillator and the second oscillator are arranged side by side, and the second oscillator is located between two first oscillators.

Each antenna unit includes a plurality of second oscillators and a plurality of first isolation members which are arranged on the carrier structure and in one-to-one correspondence with the plurality of second oscillators, and an orthogonal projection of each second oscillator on the carrier structure is located in an area defined by an orthogonal projection of a corresponding first isolation member on the carrier structure.

The first oscillator includes a first reference electrode, a first radiation structure, and a first transmission line; and

the first reference electrode is arranged on the carrier structure and has therein a first hollow-out portion, the first radiation structure penetrates through the first hollow-out portion and is arranged on the carrier structure, and the first transmission line is connected to the first radiation structure.

The first radiation structure includes a first radiation electrode, a second radiation electrode, a first connection electrode, and a first support member;

the first support member includes a first support portion and a second support portion which are arranged side by side, and a first connection portion connecting the first support portion to the second support portion, the first connection portion is arranged on the carrier structure and is positioned in the first hollow-out portion, one end of the first support portion is connected to the first connection portion, the other end of the first support portion is connected to the first radiation electrode, one end of the second support portion is connected to the first connection portion, and the other end of the second support portion is connected to the second radiation electrode; and

the first transmission line is connected to the first radiation electrode and is connected to the first connection electrode through a first via penetrating through the first radiation electrode, and the first connection electrode is connected to the second radiation electrode.

The first radiation electrode includes a first main body and a first fixing portion connected to the first main body, the second radiation electrode includes a second main body and a second fixing portion connected to the second main body, the first main body has therein a first opening, and the second main body has therein a second opening; and

the first transmission line is connected to the first fixing portion and is connected to the first connection electrode through the first via penetrating through the first fixing portion, and the first connection electrode is connected to the second fixing portion.

Each of an outer contour of the first main body and an outer contour of the second main body includes a plurality of sides, an inner angle formed by any two adjacent sides of the outer contour of the first main body is an obtuse angle, and an inner angle formed by any two adjacent sides of the outer contour of the second main body is an obtuse angle.

The first opening has the same shape as that of the outer contour of the first main body, and the second opening has the same shape as that of the outer contour of the second main body.

The second oscillator includes a second reference electrode, a second radiation structure, and a second transmission line; and

the second reference electrode is arranged on the carrier structure and has therein a second hollow-out portion, the second radiation structure penetrates through the second hollow-out portion and is arranged on the carrier structure, and the second transmission line is connected to the second radiation structure.

The second radiation structure includes a third radiation electrode, a fourth radiation electrode, a second connection electrode, and a second support member;

the second support member includes a third support portion and a fourth support portion which are arranged side by side, and a second connection portion connecting the third support portion to the fourth support portion, the second connection portion is arranged on the carrier structure and is positioned in the second hollow-out portion, one end of the third support portion is connected to the second connection portion, the other end of the third support portion is connected to the third radiation electrode, one end of the fourth support portion is connected to the second connection portion, and the other end of the fourth support portion is connected to the fourth radiation electrode; and

the second transmission line is connected to the third radiation electrode and is connected to the second connection electrode through a second via penetrating through the third radiation electrode, and the second connection electrode is connected to the fourth radiation electrode.

Each of the third radiation electrode and the fourth radiation electrode includes a first side and a second side opposite to each other, a third side and a fourth side opposite to each other, a first connection side, and a second connection side;

for the third radiation electrode, both ends of the first side are respectively connected to the third side and the fourth side, one end of the second side is connected to the third side through the first connection side, the other end of the second side is connected to the fourth side through the second connection side, and two inner angles formed by the first connection side with both the third side and the second side are both obtuse angles; and

the first side of the fourth radiation electrode is adjacent to the first side of the third radiation electrode, for the fourth radiation electrode, both ends of the first side are respectively connected to the third side and the fourth side, one end of the second side is connected to the third side through the first connection side, the other end of the second side is connected to the fourth side through the second connection side, and two inner angles formed by the first connection side with both the third side and the second side are both obtuse angles.

The carrier structure is a hollow-out structure including a plurality of carrier portions connected together sequentially, and each of the plurality of carrier portions has one of the plurality of antenna units arranged thereon.

A second isolation member is disposed between any two mutually connected carrier portions, and one of the plurality of antenna units is disposed between two adjacent second isolation members.

The antenna assembly further includes a feeding network connected to both the first transmission line and the second transmission line of each of the plurality of antenna units, and the feeding network is arranged in a cavity of the carrier structure.

The communication device further includes a pedestal and a radome, wherein the carrier structure is installed on the pedestal, and the radome is installed on an outside of the carrier structure to be mutually fixed with the pedestal, so as to house the plurality of antenna units within the radome.

The communication device further includes a sealing ring disposed between the radome and the pedestal.

Embodiments of the present disclosure provide a communication method for the communication device according to any one of the foregoing embodiments, the communication method including:
determining, by the determiner, one of the plurality of antenna units to be in communication connection with the signal converter, according to the strengths of the signals received by the plurality of antenna units from the base station; and
converting, by the signal converter, the signal received by the signal converter, for access by a terminal of a user.

The determining, by the determiner, one of the plurality of antenna units to be in communication connection with the signal converter, according to the strengths of the signals received by the plurality of antenna units from the base station includes:
coupling, by each signal coupler, a part of the signal received by the antenna unit connected to the signal coupler to a corresponding signal detector, and transmitting, by the signal coupler, another part of the signal to a first selector;
detecting, by the signal detector, the signal received by the signal detector to acquire the strength of the signal from the base station;
generating, by a controller, a corresponding control signal according to received strengths, which are detected by signal detectors, of the signals from the base station, and transmitting, by the controller, the control signal to the first selector; and
determining, by the first selector, the one of the plurality of antenna units to be in communication connection with the signal converter according to the control signal, and communicatively connecting, by the first selector, the one of the plurality of antenna units to the signal converter.

The determining, by the determiner, one of the plurality of antenna units to be in communication connection with the signal converter, according to the strengths of the signals received by the plurality of antenna units from the base station includes:
coupling, by each signal coupler, a part of the signal received by the antenna unit connected to the signal coupler to a corresponding signal preprocessor, and transmitting, by the signal coupler, another part of the signal to a first selector;
preprocessing, by each signal preprocessor, the signal received by signal preprocessor;
controlling, by a controller, a second selector to connect signal preprocessors to a signal strength reader in turn, and reading, by the signal strength reader, the signals output from the second selector to determine the strengths of the signals received by the plurality of antenna units from the base station;
generating, by the controller, a corresponding control signal according to the received strengths, which are read by the signal strength reader, of the signals from the base station, and transmitting, by the controller, the control signal to the first selector; and
determining, by the first selector, the one of the plurality of antenna units to be in communication connection with the signal converter according to the control signal, and communicatively connecting, by the first selector, the one of the plurality of antenna units to the signal converter.

### BRIEF DESCRIPTION OF THE DRAWINGS

FIG. 1 is a block diagram of a communication device according to an embodiment of the present disclosure.

FIG. 2 is a block diagram of a 5G CPE according to an embodiment of the present disclosure.

FIG. 3 is a block diagram of a first example of a station tracker according to an embodiment of the present disclosure.

FIG. 4 is a block diagram of a second example of a station tracker according to an embodiment of the present disclosure.

FIG. 5 is a perspective view of a communication device according to an embodiment of the present disclosure.

FIG. 6 is a perspective view of an antenna unit according to an embodiment of the present disclosure.

FIG. 7 is a perspective view of a low frequency oscillator according to an embodiment of the present disclosure.

FIG. 8 is a front view of a low frequency oscillator according to an embodiment of the present disclosure.

FIG. 9 is a top view of a first reference electrode of a low frequency oscillator according to an embodiment of the present disclosure.

FIG. 10 is a perspective view of a high frequency oscillator according to an embodiment of the present disclosure.

FIG. 11 is a front view of a high frequency oscillator according to an embodiment of the present disclosure.

FIG. 12 is a top view of a second reference electrode of a high frequency oscillator according to an embodiment of the present disclosure.

FIG. 13 is a horizontal directional pattern of a low frequency oscillator according to an embodiment of the present disclosure.

FIG. 14 is a horizontal directional pattern of a high frequency oscillator according to an embodiment of the present disclosure.

FIG. 15 is a directional pattern of an antenna assembly at a low frequency of 700 MHz according to an embodiment of the present disclosure.

FIG. 16 is a directional pattern of an antenna assembly at a high frequency of 2.6 GHz according to an embodiment of the present disclosure.

FIG. 17 is an exploded view of a communication device according to an embodiment of the present disclosure.

FIG. 18 is an assembly diagram of a communication device according to an embodiment of the present disclosure.

FIG. 19 is a flowchart of a communication method according to an embodiment of the present disclosure.

FIG. 20 is an exemplary flowchart of step S1 of a communication method according to an embodiment of the present disclosure.

FIG. 21 is another exemplary flowchart of step S1 of a communication method according to an embodiment of the present disclosure.

### DETAILED DESCRIPTION OF EMBODIMENTS

To help one of ordinary skill in the art better understand technical solutions of the present disclosure, the present disclosure will be further described below in detail with reference to the accompanying drawings and exemplary embodiments.

Unless defined otherwise, technical or scientific terms used herein shall have the ordinary meaning as understood by one of ordinary skill in the art to which this disclosure belongs. The use of “first”, “second”, and the like in this disclosure is not intended to indicate any order, quantity, or importance, but rather is to distinguish one element from another. Similarly, the use of “a”, “an,” “the”, or the like does not denote a limitation of quantity, but rather denotes the presence of at least one. The term “comprising”, “including”, or the like, means that the element or item preceding the term contains the element or item listed after the term and its equivalent, but does not exclude the presence of other elements or items. The term “connected”, “coupled”, or the like is not limited to physical or mechanical connections, but may include electrical connections, whether direct or indirect. The terms “upper”, “lower”, “left”, “right”, and the like are used only for indicating relative positional relationships, and when the absolute position of an object being described is changed, the relative positional relationships may also be changed accordingly.

Prior to describing exemplary embodiments of the present disclosure, it should be noted that an communication device according to an embodiment of the present disclosure may be applied to coverage of maritime area signals mainly, so as to provide a good internet surfing experience for users in ferry cabins. Apparently, the communication device according to an embodiment of the present disclosure may also be applied to an area where the coverage strength of 5G signals is weak, for example, deep in the mountains, and the like, which are not exhaustively listed here. In an embodiment of the present disclosure, a case where the communication device is applied to the maritime area for signal coverage will be taken as an example only. In the following exemplary embodiments of the present disclosure, a determiner may be a station tracker, and a signal converter is mainly used for conversion of 5G signals and may be a 5G CPE (customer premise equipment). In the following exemplary embodiments of the present disclosure, only a case where a determiner is the station tracker, and a signal converter is the 5G CPE will be taken as an example.

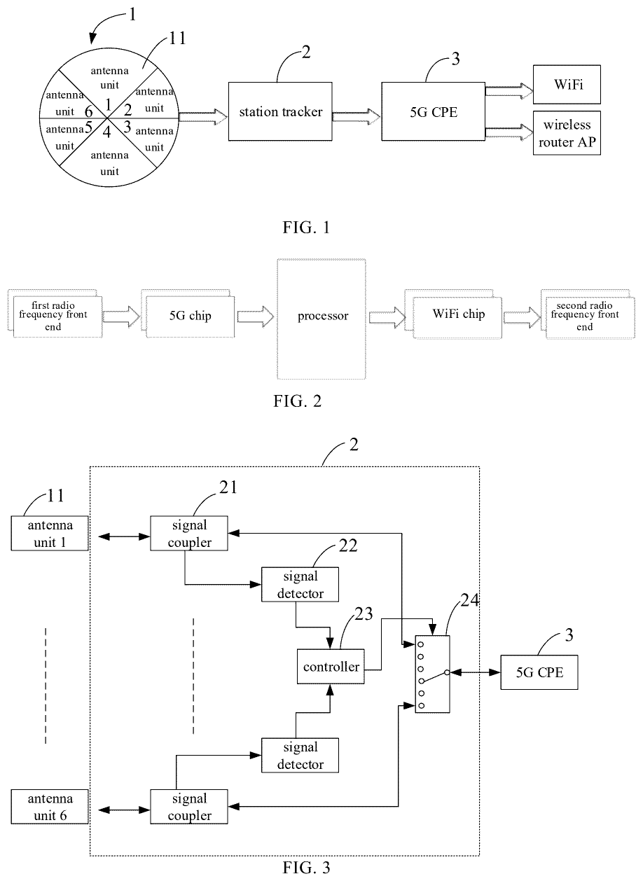

FIG. 1 is a block diagram of a communication device according to an embodiment of the present disclosure. As shown in FIG. 1, the communication device according to the present embodiment includes an antenna assembly 1, a station tracker 2, and a 5G CPE 3. The antenna assembly 1 includes a carrier structure, and a plurality of antenna units 11 mounted on an outer wall of the carrier structure. A width of a wave lobe formed by the plurality of antenna units 11 covers a target angle range. The station tracker 2 is configured to determine one of the plurality of antenna units 11 to be in communication connection with the 5G CPE 3 according to a strength of a signal received by each of the plurality of antenna units 11 from a base station. The 5G CPE 3 is configured to convert a signal received by the 5G CPE 3 for access by a terminal of a user.

In some examples, the target angle range is 360°, i.e., the antenna assembly 1 according to an embodiment of the present disclosure is an omnidirectional antenna device. In this case, each antenna unit 11 of the antenna assembly 1 covers a certain angle range, and for example, the antenna assembly 1 includes directional antennas in multiple sectors to achieve an omnidirectional coverage effect. In the present embodiment, the antenna assembly 1 is configured to include 6 sectors (i.e., 1, 2, 3, 4, 5, and 6 shown in FIG. 1), i.e., include 6 antenna units 11.

Since the antenna units 11 of the antenna assembly 1 are distributed in different sectors, positions of the antenna units 11 relative to the base station are different from each other, and therefore, strengths of signals received by the antenna units 11 from the base station are also different from each other. In an embodiment of the present disclosure, the station tracker 2 determines an antenna unit 11 to be in communication connection with the 5G CPE 3 according to the strengths of the signals received by the antenna units 11 from the base station, and controls the antenna unit 11 to communicate with the 5G CPE 3. The 5G CPE 3 performs conversion on a received signal, such that a terminal of a user can access the received signal. As such, the communication device can provide a high-quality 5G network for the user, and improves the internet surfing experience effect of the user.

In some examples, the signal strength of a signal received from the base station according to an embodiment of the present disclosure may be a power strength of the signal received from the base station.

In some examples, the 5G CPE 3 may convert the signal received from the base station to a WiFi signal for access by a terminal of a user. Alternatively, the 5G CPE 3 may be provided with a LAN port, and the user may access by means of a wireless routing AP.

Specifically, FIG. 2 is a block diagram of the 5G CPE 3. As shown in FIG. 2, the 5G CPE 3 includes a first radio frequency front end, a 5G chip, a processor, a WiFi chip, and a second radio frequency front end. The first radio frequency front end is configured to preprocess (such as amplify, filter, etc.) the signal received from the base station. The 5G chip is configured to perform digital processing, modulation, and demodulation on the received signal. The processor is configured to load an operating system, schedule and manage data resources according to a 5G protocol stack and a WiFi protocol stack, and convert a 5G signal into a WiFi signal. The WiFi chip is configured to perform digital processing, modulation, and demodulation on the WiFi signal, and output the resultant WiFi signal to the second radio frequency front end. The second radio frequency front end is configured to amplify, filter, and then transmit the WiFi signal for access by a terminal of a user.

The following two exemplary structures of the station tracker 2 are given according to embodiments of the present disclosure, and will be described in detail below.

In a first example, FIG. 3 is a block diagram of the first example of the station tracker 2 according to an embodiment of the present disclosure. As shown in FIG. 3, the station tracker 2 includes a plurality of signal couplers 21, a plurality of signal detectors 22 connected in one-to-one correspondence with the plurality of signal couplers 21, a controller 23, and a first selector 24. The plurality of signal couplers 21 may be connected in one-to-one correspondence with the plurality of antenna units 11, and each of the signal couplers 21 is connected to the first selector 24. The plurality of signal detectors 22 are connected in one-to-one correspondence with the plurality of signal couplers 21, and each of the signal detectors 22 is connected to the controller 23. The controller 23 is connected to the first selector 24. In this case, each antenna unit 11, a corresponding signal coupler 21, and a corresponding signal detector 22 form a transmission link for a signal from the base station.

Specifically, each signal coupler 21 is configured to couple a part of a signal received from the base station by the antenna unit 11 connected to the signal coupler 21 to the corresponding signal detector 22, and transmit another part of the signal to the first selector 24. It should be noted that because the signal detector 22 is configured to only analyze the strength of the signal from the base station, it is not necessary to take the part of the signal as a radiation signal. Thus, the part of the signal from the base station coupled to the signal detector 22 is much smaller than the another part of the signal from the base station transmitted to the first selector 24.

Each signal detector 22 is configured to analyze the signal received from the base station, and determine the strength of the signal received by the corresponding antenna unit 11 from the base station. The strength of the signal includes, but is not limited to, a power strength of the signal. Specifically, each signal detector 22 is configured to detect the signal received from the base station. Each signal detector 22 includes a signal preprocessor, a radio frequency power detector TruPwr, and an analog-to-digital converter ADC. The signal preprocessor performs filtering, amplification and other operations. The power detector performs detection based on a diode square law, and after bandpass filtering, a carrier voltage power is obtained. After sampling by the ADC, the carrier voltage power is input to the controller for determination processing.

The controller 23 is configured to determine the antenna unit 11 to communicate with the 5G CPE 3 according to the strengths, which are determined by the signal detectors 22, of the signals received by the antenna units 11 from the base station, and generate a corresponding control signal to be sent to an antenna selector. For example, among the plurality of antenna units 11, the antenna unit 11 which receives signal from the base station with the maximum strength is taken as the antenna unit 11 to communicate with the 5G CPE 3.

The first selector 24 is configured to transmit the signal received by a corresponding antenna unit 11 from base station to the 5G CPE 3, according to the received control signal transmitted from the controller 23.

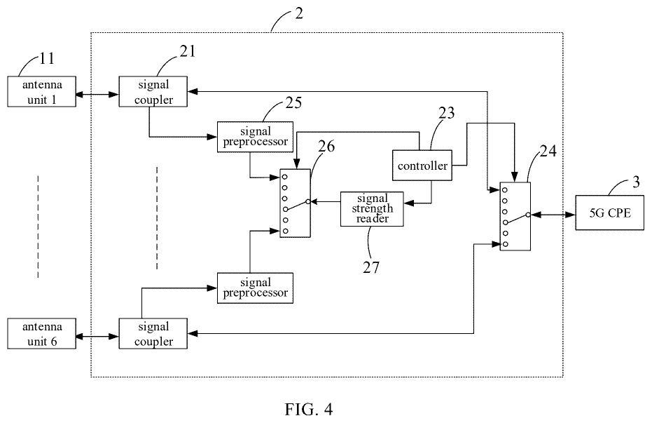

In a second example, FIG. 4 is a block diagram of the second example of the station tracker 2 according to an embodiment of the present disclosure. As shown in FIG. 4, in this example, the station tracker 2 includes a plurality of signal couplers 21, a plurality of signal preprocessors 25 connected in one-to-one correspondence with the plurality of signal couplers 21, a signal strength reader 27, a controller 23, a first selector 24, and a second selector 26. The plurality of signal couplers 21 may be connected in one-to-one correspondence with the plurality of antenna units 11, and connected in one-to-one correspondence with the plurality of signal preprocessors 25. Each of the signal preprocessors 25 is connected to the second selector 26, and the second selector 26 is connected to both the controller 23 and the signal strength reader 27. The signal strength reader 27 is further connected to the controller 23, and the controller 23 is further connected to the first selector 24. In this case, each antenna unit 11, a corresponding signal coupler 21, and a corresponding signal preprocessor 25 form a transmission link for the signal from the base station.

Specifically, each signal coupler 21 is configured to couple a part of signal received by the antenna unit 11 connected to the signal coupler 21 from the base station to the corresponding signal preprocessor 25, and transmit another part of the signal to the first selector 24. It should be noted that because the signal preprocessor 25 only preprocesses the signal from the base station to enable the signal strength reader to read the strength of the signal from the base station, it is not necessary to take the part of the signal as a radiation signal. Thus, the part of the signal from the base station coupled to the signal preprocessor 25 is much smaller than the another part of the signal from the base station transmitted to the first selector 24.

Each signal preprocessor 25 is configured to preprocess the signal received from the base station, to enable the signal strength reader to read the strength of the signal from the base station. The strength of the signal includes, but is not limited to, a power strength of the signal. Specifically, each signal preprocessor 25 is configured to perform detection, signal amplification, filtering, analog-to-digital conversion, digital signal processing, and the like on the signal received from the base station.

The controller 23 controls the second selector 26 to connect the signal preprocessors to the signal strength reader 27 in turn, to allow the signal strength reader 27 reads, by using by an AT command, the strength of the signal received by a corresponding antenna unit 11 from the base station. The signal strength reader 27 feeds back the strengths, which are read in turn, of the signals received by the antenna units 11 from the base station to the controller 23. The controller 23 controls the antenna unit 11, which receives the signal from the base station with the maximum strength, to communicate with the 5G CPE 3, according to the strengths of the signals received by the antenna units 11 from the base station.

The station tracker 2 in this example detects the signals received by the antennas from the base station in turn. As such, the number of ports of the controller 23 can be reduced, and the cost thereof can be reduced.

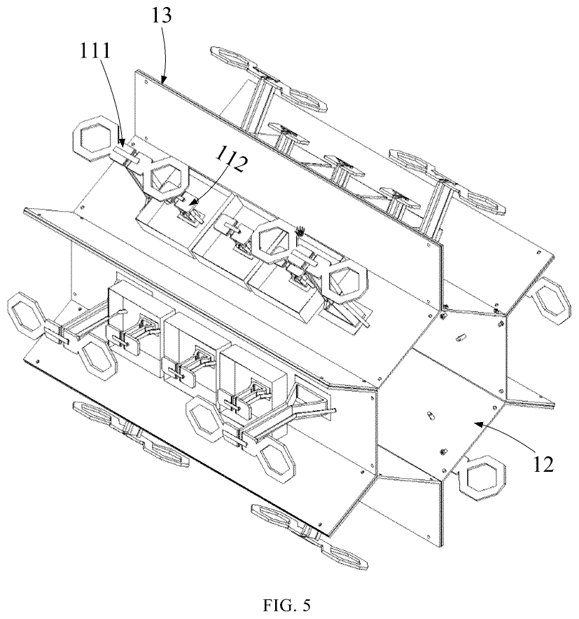

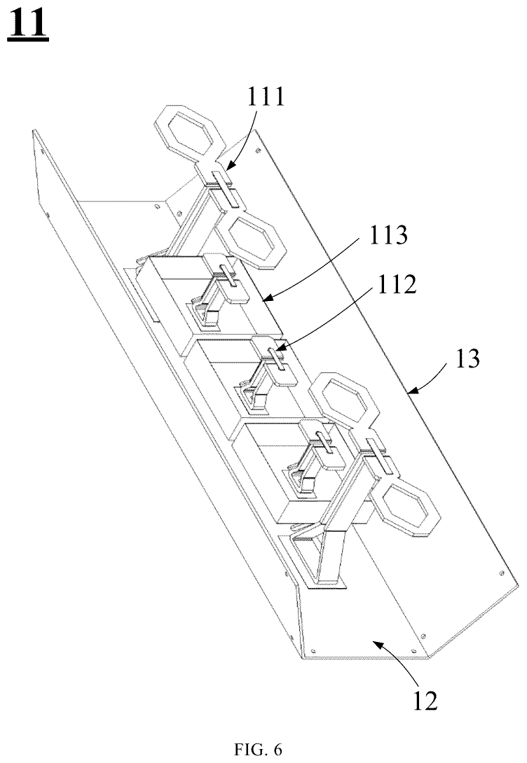

In some examples, FIG. 5 is a perspective view of a communication device according to an embodiment of the present disclosure, and FIG. 6 is a perspective view of each antenna unit 11 according to an embodiment of the present disclosure. As shown in FIGS. 5 and 6, each antenna unit 11 according to an embodiment of the present disclosure includes a first oscillator and a second oscillator, and an operational frequency of the first oscillator is smaller than an operational frequency of the second oscillator. Specifically, an operational frequency band of the first oscillator includes a low frequency of 700 MHZ, and the first oscillator operates in a frequency division duplex (FDD) mode. An operational frequency band of the second oscillator includes a high frequency of 2.6 GHz, and the second oscillator operates in a time division duplex (TDD) mode. Each of the first oscillator and the second oscillator is designed to combine a receiver and a transmitter which have a common aperture together. For convenience of description, the first oscillator is referred to as a low frequency oscillator 111, and the second oscillator is referred to as a high frequency oscillator 112.

Further, with continuing reference to FIGS. 5 and 6, in order to reduce the mutual influence between the high frequency oscillator 112 and the low frequency oscillator 111, the high frequency oscillator 112 and the low frequency oscillator 111 have heights different from each other. Specifically, for each antenna unit 11, the high frequency oscillator 112 and the low frequency oscillator 111 are arranged side by side, and the height of the low frequency oscillator 111 in a direction away from the carrier structure is greater than the height of the high frequency oscillator 112 in the direction away from the carrier structure. Furthermore, each antenna unit 11 may include a plurality of low frequency oscillators 111 and a plurality of high frequency oscillators 112, and the high frequency oscillators 112 are disposed between two adjacent low frequency oscillators 111. Specifically, in order to achieve enhanced coverage, two low frequency oscillators 111 and three high frequency oscillators 112 are arranged in each antenna unit 11, and the three high frequency oscillators 112 are arranged between the two low frequency oscillators 111; and any adjacent two high frequency oscillators 112 have an identical distance therebetween. In an embodiment of the present disclosure, a distance between any two adjacent low frequency oscillators 111 and the distance between any two adjacent high frequency oscillators 112 are both dependent on a wavelength. In some examples, each of the distance between any two adjacent low frequency oscillators 111 and the distance between any two adjacent high frequency oscillators 112 may range from 0.4 wavelengths to 0.6 wavelengths. In a specific example, the distance between any two adjacent low frequency oscillators 111 is 240 mm, and the distance between any two adjacent high frequency oscillators 112 is 75 mm, in which case a high coverage capability is achieved in a small space at a lower cost. Alternatively, the number of the low frequency oscillators 111 and the number of the high frequency oscillators 112 are not limited to the above examples. In a case where more low frequency oscillators 111 are included, distances between every two adjacent low frequency oscillators 111 should be identical to each other, and similarly, in a case where more high frequency oscillators 112 are included, distances between every two adjacent high frequency oscillators 112 should be identical to each other.

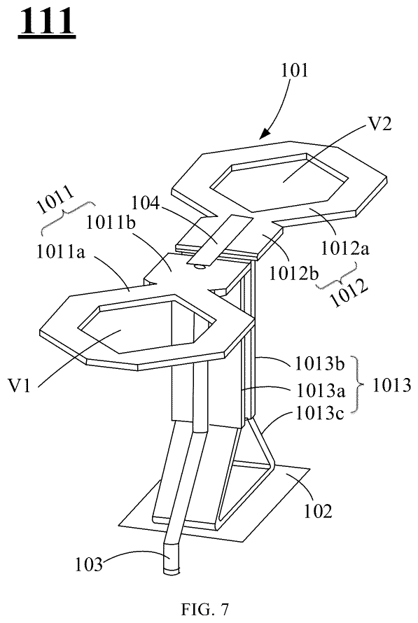

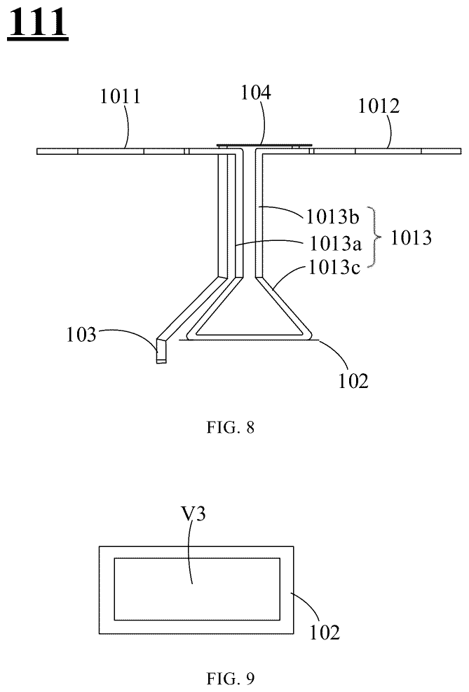

In some examples, FIG. 7 is a perspective view of each low frequency oscillator 111 according to an embodiment of the present disclosure, and FIG. 8 is a front view of each low frequency oscillator 111 according to an embodiment of the present disclosure; FIG. 9 being a top view of a first reference electrode 102 of each low frequency oscillator 111 according to an embodiment of the present disclosure. As shown in FIGS. 7 to 9, each low frequency oscillator 111 according to an embodiment of the present disclosure includes the first reference electrode 102, a first radiation structure 101, and a first transmission line 103. The first reference electrode 102 is arranged on the carrier structure, and has a first hollow-out portion V3 therein. The first radiation structure 101 penetrates through the first hollow-out portion and is arranged on the carrier structure. The first transmission line 103 and the first radiation structure 101 are connected to each other. The first reference electrode 102 and the first radiation structure 101 can form an electrical current loop, and the first transmission line 103 is configured to transmit a radio frequency signal to the first radiation structure 101.

The first radiation structure 101 includes a first support member 1013, a first radiation electrode 1011, and a second radiation electrode 1012. The first support member 1013 may include a first support portion 1013a and a second support portion 1013b which are arranged side by side, and a first connection portion 1013c connecting the first support portion 1013a with the second support portion 1013b. The first connection portion 1013c is disposed on the carrier structure and located in the first hollow-out portion V3. One end of the first support portion 1013a is connected to the first connection portion 1013c, and the other end of the first support portion 1013a is connected to the first radiation electrode 1011. One end of the second support portion 1013b is connected to the first connection portion 1013c, and the other end of the second support portion 1013b is connected to the second radiation electrode 1012. The first transmission line 103 is connected to the first radiation electrode 1011, and is connected to a first connection electrode 104 through a first via penetrating through the first radiation electrode 1011. The first connection electrode 104 is connected to the second radiation electrode 1012.

Referring to FIG. 7, in the first support member 1013, the first support portion 1013a, the second support portion 1013b, and the first connection portion 1013c have a one-piece structure, and a width of a part of the first connection portion 1013c distal to the carrier structure is greater than a distance between the first support portion 1013a and the second support portion 1013b, to provide a stable support.

Referring to FIG. 7, the first radiation electrode 1011 includes a first main body 1011a and a first fixing portion 1011b connected to the first main body 1011a. The second radiation electrode 1012 includes a second main body 1012a and a second fixing portion 1012b connected to the second main body 1012a. The first main body 1011a has a first opening V1 therein, and the second main body 1012a has a second opening V2 therein. The first transmission line 103 is connected to the first fixing portion 1011b, and connected to the first connection electrode 104 through the first via penetrating through the first fixing portion 1011b. The first connection electrode 104 is connected to the second fixing portion 1012b. In this case, by providing the first opening VI in the first main body 1011a and providing the second opening V2 in the second main body 1012a, an electrical current path can be extended, and a gain can be improved.

Furthermore, an outer contour of each of the first main body 1011a and the second main body 1012a includes a plurality of sides. An inner angle formed by any two adjacent sides of the outer contour of the first main body 1011a is an obtuse angle, and an inner angle formed by any two adjacent sides of the outer contour of the second main body 1012a is an obtuse angle. Since the inner angles of each of the first main body 1011a and the second main body 1012a are obtuse angles, electromagnetic wave reflection can be reduced, and a loss of an electromagnetic wave can be reduced. Further, the first opening VI has the same shape as that of the outer contour of the first main body 1011a, and the second opening V2 has the same shape as that of the outer contour of the second main body 1012a.

For example, the outer contour of the first main body 1011a is a regular hexagon, and the shape of the first opening V1 is a regular hexagon; the outer contour of the second main body 1012a is a regular hexagon, and the shape of the second opening V2 is a regular hexagon. Alternatively, in some examples, the shape of the first opening V1 is different from the outer contour of the first main body 1011a, and the shape of the second opening V2 is different from the outer contour of the second main body 1012a. For example: the outer contour of the first main body 1011a is a regular hexagon, whereas the shape of the first opening VI is a circle; the outer contour of the second main body 1012a is a regular hexagon, whereas the shape of the second opening V2 is a circle. The arrangement of the first opening V1 of the first radiation electrode 1011 and the second opening V2 of the second radiation electrode 1012 in each low frequency oscillator 111 can effectively prevent each high frequency oscillator 112 from being shielded.

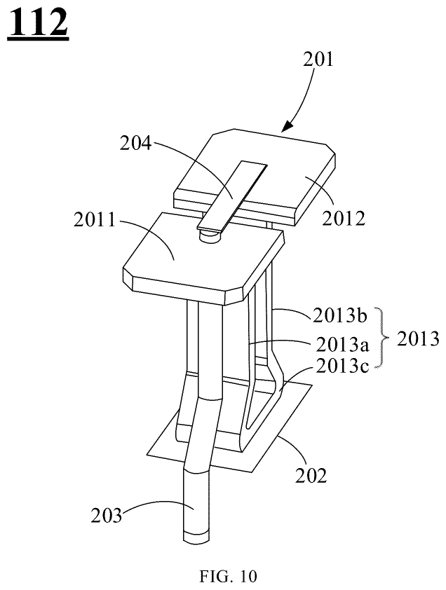

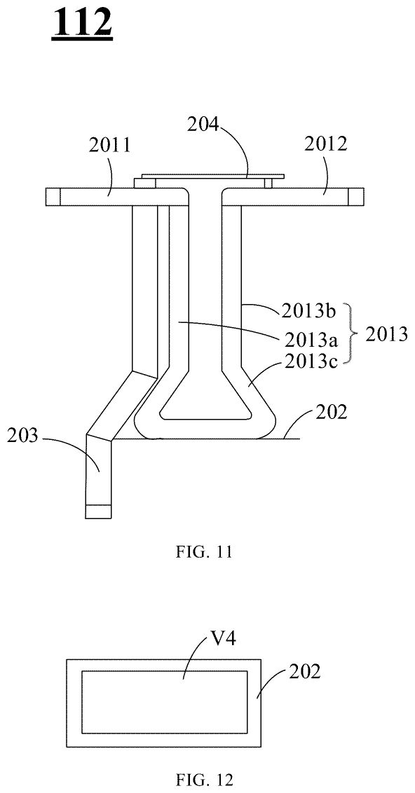

In some examples, FIG. 10 is a perspective view of each high frequency oscillator 112 according to an embodiment of the present disclosure, and FIG. 11 is a front view of each high frequency oscillator 112 according to an embodiment of the present disclosure, FIG. 12 being a top view of a second reference electrode 202 of each high frequency oscillator 112 according to an embodiment of the present disclosure. As shown in FIGS. 10 to 12, each high frequency oscillator 112 according to an embodiment of the present disclosure includes the second reference electrode 202, a second radiation structure 201, and a second transmission line 203. The second reference electrode 202 is disposed on the carrier structure, and has a second hollow-out portion V4. The second radiation structure 201 penetrates through the second hollow-out portion V4, and is disposed on the carrier structure. The second transmission line 203 is connected to the second radiation structure 201. The second reference electrode 202 and the second radiation structure 201 may form an electrical current loop, and the second transmission line 203 is configured to transmit a radio frequency signal to the second radiation structure 201.

The second radiation structure 201 includes a third radiation electrode 2011, a fourth radiation electrode 2012, a second connection electrode 204, and a second support member 2013. The second support member 2013 may include a third support portion 2013a and a fourth support portion 2013b which are arranged side by side, and a second connection portion 2013c connecting the third support portion 2013a with the fourth support portion 2013b. The second connection portion 2013c is disposed on the carrier structure and located in the second hollow-out portion V4. One end of the third support portion 2013a is connected to the second connection portion 2013c, and the other end of the third support portion 2013a is connected to the third radiation electrode 2011. One end of the fourth support portion 2013b is connected to the second connection portion 2013c, and the other end of the fourth support portion 2013b is connected to the fourth radiation electrode 2012. The second transmission line 203 is connected to the third radiation electrode 2011, and is connected to the second connection electrode 204 through a second via penetrating through the third radiation electrode 2011. The second connection electrode 204 is connected to the fourth radiation electrode 2012.

Referring to FIG. 10, in the second support member 2013, the third support portion 2013a, the fourth support portion 2013b, and the second connection portion 2013c form a one-piece structure, and a width of a part of the second connection portion 2013c distal to the carrier structure is greater than a distance between the third support portion 2013a and the fourth support portion 2013b, to provide a stable support.

With continuing reference to FIG. 10, each of the third radiation electrode 2011 and the fourth radiation electrode 2012 includes a first side and a second side opposite to each other, a third side and a fourth side opposite to each other, a first connection side, and a second connection side. For the third radiation electrode 2011, both ends of the first side are respectively connected to the third side and the fourth side; one end of the second side is connected to the third side through the first connection side, and the other end of the second side is connected to the fourth side through the second connection side; and two inner angles formed by the first connection side with both the third side and the second side are both obtuse angles. The first side of the fourth radiation electrode 2012 is adjacent to the first side of the third radiation electrode 2011; for the fourth radiation electrode 2012, both ends of the first side are respectively connected to the third side and the fourth side; one end of the second side is connected to the third side through the first connection side, and the other end of the second side is connected to the fourth side through the second connection side; and two inner angles formed by the first connection side with both the third side and the second side are both obtuse angles. That is, each of the third radiation electrode 2011 and the fourth radiation electrode 2012 may be obtained by chamfering a square patch. Each of the third radiation electrode 2011 and the fourth radiation electrode 2012 which have such a structure can not only extend an electrical current path to achieve miniaturization of an antenna, but also reduce a loss of a microwave.

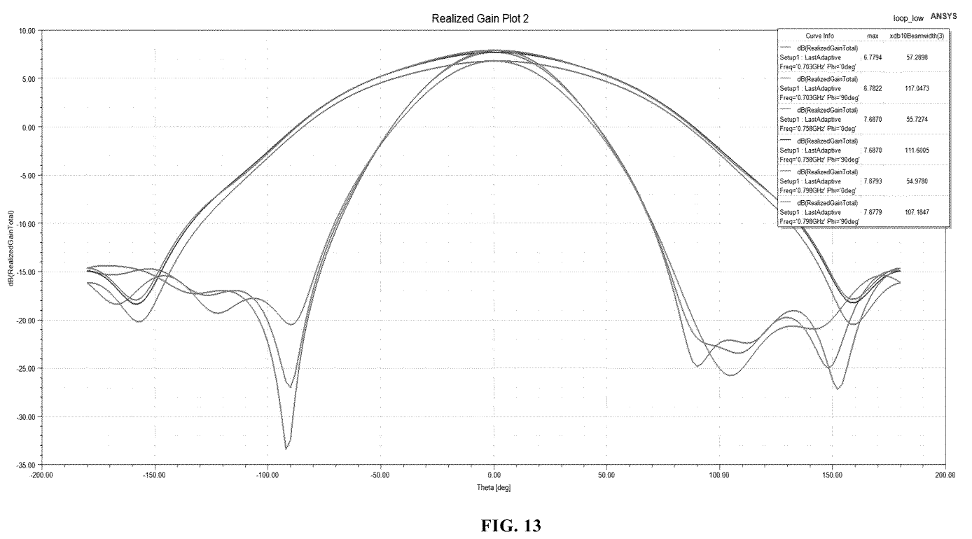

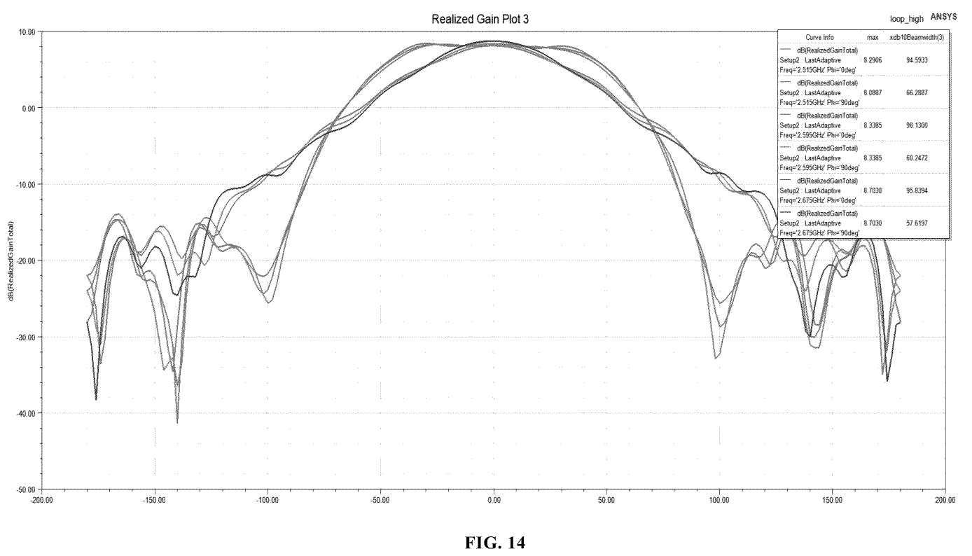

In the case where each low frequency oscillator 111 has the structure as shown in FIG. 7, a circumference of the outer contour of each of the first radiation electrode 1011 and the second radiation electrode 1012 of the low frequency oscillator 111 may range from 0.2 wavelengths to 0.3 wavelengths. The maximum side of an outer contour of each of the third radiation electrode 2011 and the fourth radiation electrode 2012 of each high frequency oscillator 112 may have a length ranging from 0.2 wavelengths to 0.3 wavelengths. In an example, the maximum side of each of the first radiation electrode 1011 and the second radiation electrode 1012 has a length of 22 mm, and a height of the first support member 1013 is 98 mm; in this case, a horizontal pattern obtained by simulating the low frequency oscillator 111 is as shown in FIG. 13, and a gain of the low frequency oscillator 111 can reach 7.6 dBi. In the case where each high frequency oscillator 112 has the structure as shown in FIG. 10, the maximum side of each of the third radiation electrode 2011 and the fourth radiation electrode 2012 has a length of 18 mm, and a height of the second support member 2013 is 36.5 mm; in this case, a horizontal pattern obtained by simulating the high frequency oscillator 112 is as shown in FIG. 14, and a gain of the high frequency oscillator 112 can reach 8.3 dBi.

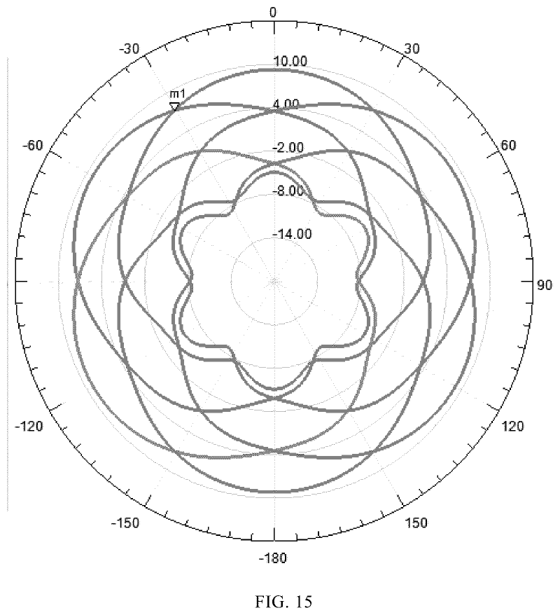

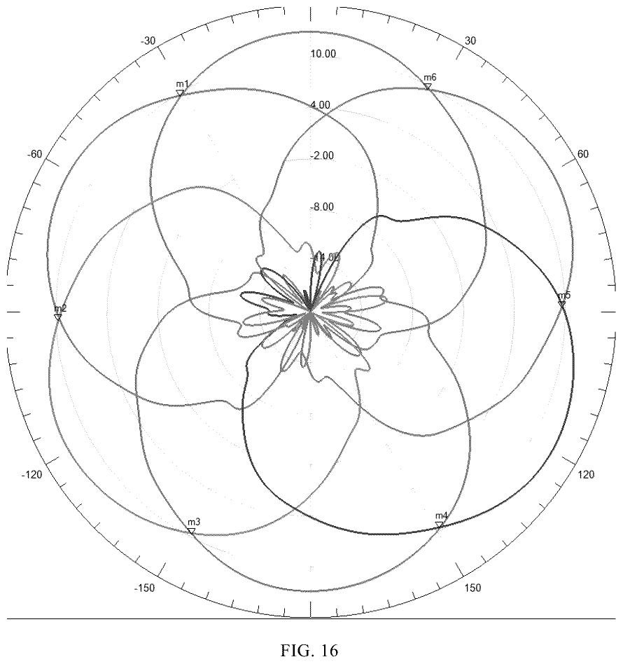

In the case where each antenna unit 11 is formed by 3 high frequency oscillators 112 and 2 low frequency oscillators 111, and where the antenna assembly 1 is formed by six antenna units 11, as the specific structure shown in FIG. 5, a directional pattern of the antenna assembly 1 at the low frequency of 700 MHz is as shown in FIG. 15, and a directional pattern of the antenna assembly 1 at the high frequency of 2.6 GHz is as shown in FIG. 16. As shown in FIGS. 15 and 16, compared with a traditional omnidirectional antenna, the gain of the antenna assembly 1 is improved by more than 3 dB. According to the Friis Transmission Equation, an increase in a gain of an antenna can result in an increase in a coverage distance, in the case where other conditions remain unchanged.

In some examples, the second reference electrode 202 of the second radiation structure 201 and the first reference electrode 102 of the first radiation structure 101 may have a one-piece structure, which is simple and convenient to be controlled.

In some examples, each of the first radiation structure 101 of each low frequency oscillator 111 and the second radiation structure 201 of each high frequency oscillator 112 may be a metal sheet metal piece.

In some examples, the carrier structure may be a hollow-out structure, and a feeding network of the antenna assembly 1 may be disposed in a cavity (which has a hollow-out central portion therein) of the carrier structure and connected to both the first transmission line 103 and the second transmission line 203 of each antenna unit 11. For example, the feeding network may include a first feeding network and a second feeding network; the first transmission line 103 of each antenna unit 11 may be electrically connected to the first feeding network through a via penetrating through the carrier structure, and the second transmission line 203 of each antenna unit 11 may be electrically connected to the second feeding network through a via penetrating through the carrier structure. In this case, the antenna assembly 1 has a simple structure and is easily miniaturized.

In some examples, referring to FIGS. 5 and 6, each antenna unit 11 further includes a first isolation member 113 disposed corresponding to each high frequency oscillator 112, and an orthogonal projection of each high frequency oscillator 112 on the carrier structure is located in an area defined by an orthogonal projection of a corresponding first isolation member 113 on the carrier structure. The high frequency oscillators 112 and the low frequency oscillators 111 are prevented from interfering with each other by the first isolation members 113. Each first isolation member 113 may be a ring fence structure formed by sequentially splicing separate isolation plates together, for example, may be a square fence structure formed by sequentially splicing four separate isolation plates together.

In some examples, referring to FIG. 5, the carrier structure may be formed by sequentially connecting a plurality of carrier portions 12, and each of the carrier portions 12 has one of the antenna units 11 disposed thereon. A second isolation member 13 is arranged between any two mutually connected carrier portions 12, and one of the antenna units 11 is arranged between two adjacent second isolation members 13. Each second isolation member 13 is provided to prevent the two antenna units 11 disposed adjacent to the second isolation member 13 from interfering with each other.

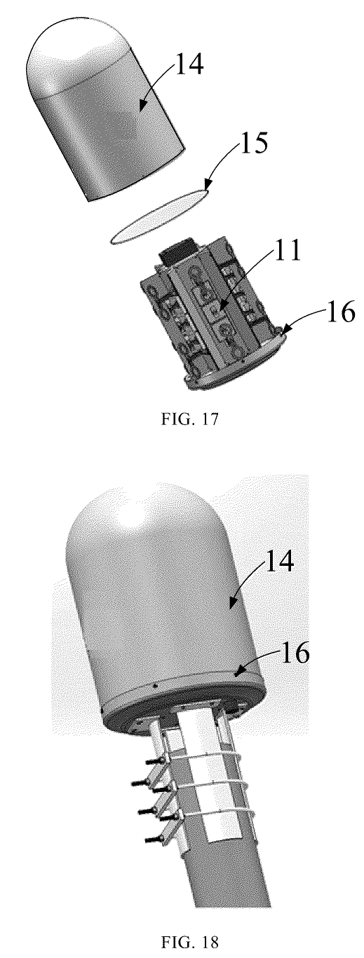

In some examples, FIG. 17 is an exploded view of a communication device according to an embodiment of the present disclosure, and FIG. 18 is an assembly view of a communication device according to an embodiment of the present disclosure. As shown in FIGS. 17 and 18, the communication device according to the present embodiment includes not only the above structures, but also a pedestal 16 and a radome 14 (i.e., an antenna cover). The carrier structure is installed on the pedestal 16. The radome 14 is arranged on an outside of the carrier structure to be fixed with the pedestal 16, so as to house the antenna units 11 within the pedestal 16. The radome 14 is configured to protect the antenna assembly 1, and thus should be made of a waterproof material, such as polytetrafluoroethylene, and should have a one-piece structure. Further, a sealing ring 15, such as a waterproof gasket, is arranged between the radome 14 and the pedestal 16, such that the effect of further sealing and waterproofing can be achieved. The radome 14 and the pedestal 16 may be fastened by screws.

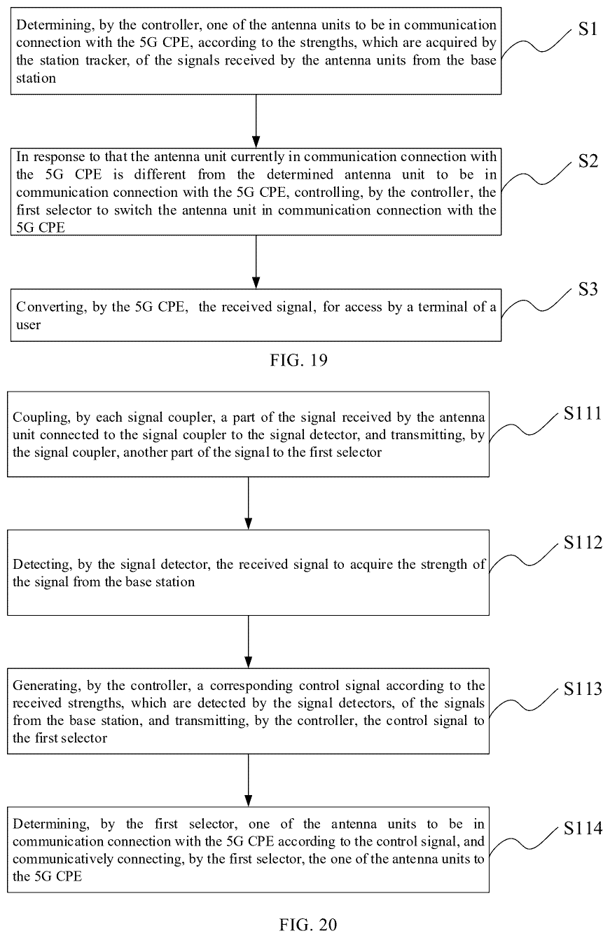

FIG. 19 is a flowchart of a communication method according to an embodiment of the present disclosure. As shown in FIG. 19, an embodiment of the present disclosure further provides a communication method for the communication device, and the communication method may include the following steps S1 to S3.

Step S1 includes determining, by the controller 23, one of the antenna units 11 to be in communication connection with the 5G CPE 3, according to the strengths, which are acquired by the station tracker 2, of the signals received by the antenna units 11 from the base station.

Step S2 includes, in response to that the antenna unit 11 currently in communication connection with the 5G CPE 3 is different from the determined antenna unit 11 to be in communication connection with the 5G CPE 3, controlling, by the controller 23, the first selector 24 to switch the antenna unit 11 in communication connection with the 5G CPE 3.

Step S3 includes, converting, by the 5G CPE 3, the received signal, for access by a terminal of a user.

In the communication method according to an embodiment of the present disclosure, the station tracker 2 determines the strengths of the signals received by the antenna units 11 from the base station, and then one of the antenna units 11 that receives the signal with the maximum strength from the base station is determined as the antenna unit 11 to be in communication connection with the 5G CPE 3. In this way, the signal output from the 5G CPE 3 also has the maximum strength, thereby improving the internet surfing experience of the user.

In some examples, FIG. 20 is a detailed flowchart of step S1 of the communication method according to the embodiment of the present disclosure. As shown in FIG. 20, step S1 of determining, by the controller 23, one of the antenna units 11 to be in communication connection with the 5G CPE 3, according to the strengths, which are acquired by the station tracker 2, of the signals received by the antenna units 11 from the base station may include the following steps S111 to S114.

Step S111 includes, coupling, by each signal coupler, a part of the signal received by the antenna unit 11 connected to the signal coupler to the signal detector 22, and transmitting, by the signal coupler, another part of the signal to the first selector 24.

Step S112 includes detecting, by the signal detector 22, the received signal to acquire the strength of the signal from the base station.

Step S113 includes generating, by the controller 23, a corresponding control signal according to the received strengths, which are detected by the signal detectors 22, of the signals from the base station, and transmitting, by the controller 23, the control signal to the first selector 24.

Step S114 includes determining, by the first selector 24, one of the antenna units 11 to be in communication connection with the 5G CPE 3 according to the control signal, and communicatively connecting, by the first selector 24, the one of the antenna units 11 to the 5G CPE 3.

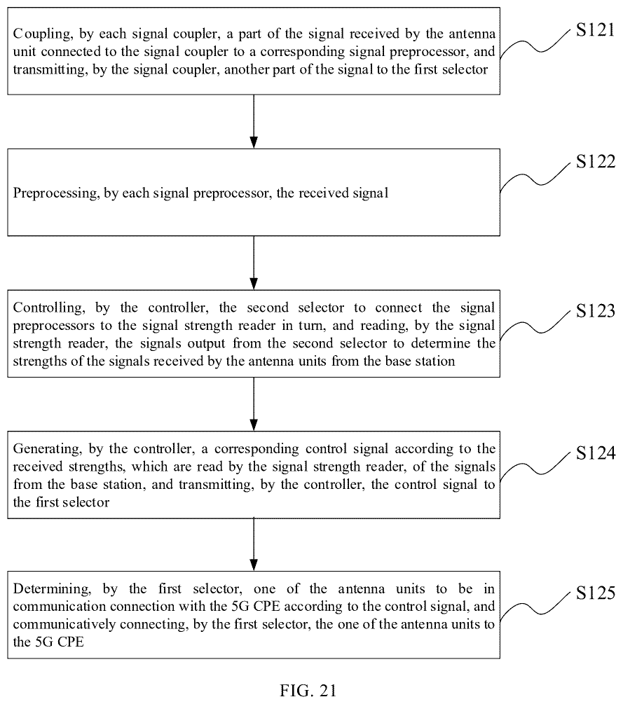

In some examples, FIG. 21 is another detailed flowchart of step S1 of the communication method according to the embodiment of the present disclosure. As shown in FIG. 21, step S1 of determining, by the controller 23, one of the antenna units 11 to be in communication connection with the 5G CPE 3, according to the strengths, which are acquired by the station tracker 2, of the signals received by the antenna units 11 from the base station may include the following steps S121 to S125.

Step S121 includes coupling, by each signal coupler, a part of the signal received by the antenna unit 11 connected to the signal coupler to a corresponding signal preprocessors 25, and transmitting, by the signal coupler, another part of the signal to the first selector 24.

Step S122 includes preprocessing, by each signal preprocessor, the received signal.

Step S123 includes controlling, by the controller 23, the second selector 26 to connect the signal preprocessors 25 to the signal strength reader 27 in turn, and reading, by the signal strength reader 27, the signals output from the second selector 26 to determine the strengths of the signals received by the antenna units 11 from the base station.

Step S124 includes generating, by the controller 23, a corresponding control signal according to the received strengths, which are read by the signal strength reader, of the signals from the base station, and transmitting, by the controller 23, the control signal to the first selector 24.

Step S125 includes determining, by the first selector 24, one of the antenna units 11 to be in communication connection with the 5G CPE 3 according to the control signal, and communicatively connecting, by the first selector 24, the one of the antenna units 11 to the 5G CPE 3.

It should be understood that the foregoing embodiments are merely exemplary embodiments adopted to illustrate the principles of the present disclosure, and the present disclosure is not limited thereto. It would be apparent to one of ordinary skill in the art that various modifications and improvements may be made therein without departing from the spirit and scope of the present disclosure, and such modifications and improvements are also considered to be within the scope of the present disclosure.

1. A communication device, comprising an antenna assembly, a determiner, and a signal converter, wherein
the antenna assembly comprises a carrier structure and a plurality of antenna units arranged on an outer wall of the carrier structure;
the determiner is configured to determine one of the plurality of antenna units to be in communication connection with the signal converter, according to strengths of signals received by the plurality of antenna units from a base station; and
the signal converter is configured to convert a signal received by the signal converter, for access by a terminal of a user.

2. The communication device according to claim 1, wherein the determiner comprises a plurality of signal couplers, a plurality of signal detectors connected in one-to-one correspondence with the plurality of signal couplers, a controller, and a first selector;
the plurality of signal couplers are connected in one-to-one correspondence with the plurality of antenna units, each signal coupler is configured to couple a part of a signal received by the antenna unit connected to the signal coupler to a corresponding signal detector, and transmit another part of the signal to the first selector;
each signal detector is configured to detect a signal received by the signal detector to acquire the strength of the signal from the base station;
the controller is configured to generate a corresponding control signal according to received strengths, which are detected by the plurality of signal detectors, of the signals from the base station, and transmit the control signal to the first selector; and
the first selector is configured to determine the one of the plurality of antenna units to be in communication connection with the signal converter according to the control signal, and communicatively connect the one of the plurality of antenna units to the signal converter.

3. The communication device according to claim 1, wherein the determiner comprises a plurality of signal couplers, a plurality of signal preprocessors connected in one-to-one correspondence with the plurality of signal couplers, a signal strength reader, a first selector, a controller, and a second selector;
the plurality of signal couplers are connected in one-to-one correspondence with the plurality of antenna units, each signal coupler is configured to couple a part of a signal received by the antenna unit connected to the signal coupler to a corresponding signal preprocessor, and transmit another part of the signal to the first selector;
each signal preprocessor is configured to preprocess a signal received by the signal preprocessor;
the second selector is configured to connect the plurality of signal preprocessors to the signal strength reader in turn, under control of the controller;
the signal strength reader is configured to read signals output from the second selector under the control of the controller, and to determine the strengths of the signals received by the plurality of antenna units from the base station;
the controller is configured to generate a corresponding control signal according to received strengths, which are read by the signal strength reader, the signals from the base station, and transmit the corresponding control signal to the first selector; and
the first selector is configured to determine the one of the plurality of antenna units to be in communication connection with the signal converter according to the control signal, and communicatively connect the one of the plurality of antenna units to the signal converter.

4. The communication device according to claim 1, wherein each of the strengths of the signals comprises at least a signal reception power;
or
wherein the signal converter is a 5G CPE.

5. The communication device according to claim 1, wherein each antenna unit comprises a first oscillator and a second oscillator, and the first oscillator has an operational frequency less than an operational frequency of the second oscillator.

6. The communication device according to claim 5, wherein in each antenna unit, the first oscillator and the second oscillator are arranged side by side, and a height of the first oscillator in a direction away from the carrier structure is greater than a height of the second oscillator in the direction away from the carrier structure.

7. The communication device according to claim 5, wherein in each antenna unit, the first oscillator and the second oscillator are arranged side by side, and the second oscillator is located between two first oscillators.

8. The communication device according to claim 7, wherein each antenna unit comprises a plurality of second oscillators and a plurality of first isolation members which are arranged on the carrier structure and in one-to-one correspondence with the plurality of second oscillators, and an orthogonal projection of each second oscillator on the carrier structure is located in an area defined by an orthogonal projection of a corresponding first isolation member on the carrier structure.

9. The communication device according to claim 5, wherein the first oscillator comprises a first reference electrode, a first radiation structure, and a first transmission line; and
the first reference electrode is arranged on the carrier structure and has therein a first hollow-out portion, the first radiation structure penetrates through the first hollow-out portion and is arranged on the carrier structure, and the first transmission line is connected to the first radiation structure.

10. The communication device according to claim 9, wherein the first radiation structure comprises a first radiation electrode, a second radiation electrode, a first connection electrode, and a first support member;
the first support member comprises a first support portion and a second support portion which are arranged side by side, and a first connection portion connecting the first support portion to the second support portion, the first connection portion is arranged on the carrier structure and is positioned in the first hollow-out portion, one end of the first support portion is connected to the first connection portion, the other end of the first support portion is connected to the first radiation electrode, one end of the second support portion is connected to the first connection portion, and the other end of the second support portion is connected to the second radiation electrode; and
the first transmission line is connected to the first radiation electrode and is connected to the first connection electrode through a first via penetrating through the first radiation electrode, and the first connection electrode is connected to the second radiation electrode.

11. The communication device according to claim 10, wherein the first radiation electrode comprises a first main body and a first fixing portion connected to the first main body, the second radiation electrode comprises a second main body and a second fixing portion connected to the second main body, the first main body has therein a first opening, and the second main body has therein a second opening; and
the first transmission line is connected to the first fixing portion and is connected to the first connection electrode through the first via penetrating through the first fixing portion, and the first connection electrode is connected to the second fixing portion.

12. The communication device according to claim 11, wherein each of an outer contour of the first main body and an outer contour of the second main body comprises a plurality of sides, an inner angle formed by any two adjacent sides of the outer contour of the first main body is an obtuse angle, and an inner angle formed by any two adjacent sides of the outer contour of the second main body is an obtuse angle;
or
wherein the first opening has the same shape as that of the outer contour of the first main body, and the second opening has the same shape as that of the outer contour of the second main body.

13. (canceled)

14. The communication device according to claim 5, wherein the second oscillator comprises a second reference electrode, a second radiation structure, and a second transmission line; and
the second reference electrode is arranged on the carrier structure and has therein a second hollow-out portion, the second radiation structure penetrates through the second hollow-out portion and is arranged on the carrier structure, and the second transmission line is connected to the second radiation structure.

15. The communication device according to claim 14, wherein the second radiation structure comprises a third radiation electrode, a fourth radiation electrode, a second connection electrode, and a second support member;
the second support member comprises a third support portion and a fourth support portion which are arranged side by side, and a second connection portion connecting the third support portion to the fourth support portion, the second connection portion is arranged on the carrier structure and is positioned in the second hollow-out portion, one end of the third support portion is connected to the second connection portion, the other end of the third support portion is connected to the third radiation electrode, one end of the fourth support portion is connected to the second connection portion, and the other end of the fourth support portion is connected to the fourth radiation electrode; and
the second transmission line is connected to the third radiation electrode and is connected to the second connection electrode through a second via penetrating through the third radiation electrode, and the second connection electrode is connected to the fourth radiation electrode.

16. The communication device according to claim 15, wherein each of the third radiation electrode and the fourth radiation electrode comprises a first side and a second side opposite to each other, a third side and a fourth side opposite to each other, a first connection side, and a second connection side;
for the third radiation electrode, both ends of the first side are respectively connected to the third side and the fourth side, one end of the second side is connected to the third side through the first connection side, the other end of the second side is connected to the fourth side through the second connection side, and two inner angles formed by the first connection side with both the third side and the second side are both obtuse angles; and
the first side of the fourth radiation electrode is adjacent to the first side of the third radiation electrode, for the fourth radiation electrode, both ends of the first side are respectively connected to the third side and the fourth side, one end of the second side is connected to the third side through the first connection side, the other end of the second side is connected to the fourth side through the second connection side, and two inner angles formed by the first connection side with both the third side and the second side are both obtuse angles.

17. The communication device according to claim 1, wherein the carrier structure is a hollow-out structure comprising a plurality of carrier portions connected together sequentially, and each of the plurality of carrier portions has one of the plurality of antenna units arranged thereon.

18. The communication device according to claim 17, wherein a second isolation member is disposed between any two mutually connected carrier portions, and one of the plurality of antenna units is disposed between two adjacent second isolation members;
or
wherein the antenna assembly further comprises a feeding network connected to both the first transmission line and the second transmission line of each of the plurality of antenna units, and the feeding network is arranged in a cavity of the carrier structure;
or
the communication device further comprises a pedestal and a radome, wherein the carrier structure is installed on the pedestal, and the radome is installed on an outside of the carrier structure to be mutually fixed with the pedestal, so as to house the plurality of antenna units within the radome;
or
the communication device further comprises a sealing ring disposed between the radome and the pedestal

19-22. (canceled)

23. A communication method for the communication device according to claim 1, the communication method comprising:
determining, by the determiner, one of the plurality of antenna units to be in communication connection with the signal converter, according to the strengths of the signals received by the plurality of antenna units from the base station; and
converting, by the signal converter, the signal received by the signal converter, for access by a terminal of a user.

24. The communication method according to claim 23, wherein the determining, by the determiner, one of the plurality of antenna units to be in communication connection with the signal converter, according to the strengths of the signals received by the plurality of antenna units from the base station comprises:
coupling, by each signal coupler, a part of the signal received by the antenna unit connected to the signal coupler to a corresponding signal detector, and transmitting, by the signal coupler, another part of the signal to a first selector;
detecting, by the signal detector, the signal received by the signal detector to acquire the strength of the signal from the base station;
generating, by a controller, a corresponding control signal according to received strengths, which are detected by signal detectors, of the signals from the base station, and transmitting, by the controller, the control signal to the first selector; and
determining, by the first selector, the one of the plurality of antenna units to be in communication connection with the signal converter according to the control signal, and communicatively connecting, by the first selector, the one of the plurality of antenna units to the signal converter.

25. The communication method according to claim 23, wherein the determining, by the determiner, one of the plurality of antenna units to be in communication connection with the signal converter, according to the strengths of the signals received by the plurality of antenna units from the base station comprises:
coupling, by each signal coupler, a part of the signal received by the antenna unit connected to the signal coupler to a corresponding signal preprocessor, and transmitting, by the signal coupler, another part of the signal to a first selector;
preprocessing, by each signal preprocessor, the signal received by signal preprocessor;
controlling, by a controller, a second selector to connect signal preprocessors to a signal strength reader in turn, and reading, by the signal strength reader, the signals output from the second selector to determine the strengths of the signals received by the plurality of antenna units from the base station;
generating, by the controller, a corresponding control signal according to the received strengths, which are read by the signal strength reader, of the signals from the base station, and transmitting, by the controller, the control signal to the first selector; and
determining, by the first selector, the one of the plurality of antenna units to be in communication connection with the signal converter according to the control signal, and communicatively connecting, by the first selector, the one of the plurality of antenna units to the signal converter.
